(19) United States
(12) Patent Application Publication
(10) Pub. No.: US 2015/0279131 A1
(43) Pub. Date: Oct. 1, 2015

(54) KEY FOB AND SMARTDEVICE GESTURES FOR VEHICLE FUNCTIONS

(71) Applicant: DENSO International America, Inc., Southfield, MI (US)

(72) Inventor: Martin Nespolo, Rochester Hills (AR)

(73) Assignee: DENSO International America, Inc., Southfield, MI (US)

(21) Appl. No.: 14/229,239

(22) Filed: Mar. 28, 2014

(51) Int. Cl. G07C 9/00

(52) U.S. Cl. CPC G07C 9/00087; G07C 9/00182; G07C 2009/00277; G07C 2009/00301

(57) ABSTRACT

A system for remotely controlling functions of a vehicle. The system includes a transmitter, a charge storage device, an accelerometer, and a controller. The controller is configured to identify gestures made by a user moving the accelerometer. The gestures represent functional commands to be transmitted to the vehicle with the transmitter.

### FIELD

The present disclosure relates to key fob and smartdevice gestures for controlling functions of a vehicle.

### BACKGROUND

This section provides background information related to the present disclosure which is not necessarily prior art.

Many vehicles have a remote keyless entry system including a key fob that transmits a wireless signal to the vehicle for controlling, for example, the door locks, trunk, lift gate, and remote start features. The key fob generally includes one or more functional buttons, a circuit board, a charge storage device (such as a battery), and an enclosure often made from a polymeric material. Such remote keyless entry systems are suitable for their intended use, but are subject to improvement. For example, it may be difficult to actuate the functional button if the user has his/her hands full. Elderly and/or disabled persons may also find it difficult to actuate the button. An improved remote keyless entry system that provides additional options for a user to transmit functional commands to his/her vehicle would thus be desirable.

### SUMMARY

This section provides a general summary of the disclosure, and is not a comprehensive disclosure of its full scope or all of its features.

The present teachings provide for a system for remotely controlling functions of a vehicle. The system includes a transmitter, a charge storage device, an accelerometer, and a controller. The controller is configured to identify gestures made by a user moving the accelerometer. The gestures represent functional commands to be transmitted to the vehicle with the transmitter.

The present teachings further include a device for remotely controlling functions of a vehicle. The device includes a transmitter, a charge storage device, an accelerometer, a controller, and a housing. The controller is configured to identify gestures made by a user moving the accelerometer. The gestures represent functional commands to be transmitted to the vehicle with the transmitter. The housing includes each one of the transmitter, the charge storage device, the accelerometer, and the controller.

The present teachings also provide for a method for remotely controlling functions of a vehicle. The method includes: identifying air gestures made by a user moving an accelerometer, the air gestures identified by a controller and representing functional commands for the vehicle; and transmitting the functional commands to the vehicle.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1A is a schematic of a device for remotely controlling functions of a vehicle according to the present teachings;

FIG. 1B is a secondary device according to the present teachings for remotely controlling functions of a vehicle;

FIG. 2A illustrates the secondary device of FIG. 1B included in a cane;

FIG. 2B illustrates the secondary device of FIG. 1B included in a shoe, and an exemplary gesture made by a user moving the secondary device, the gesture representing a desired function to be performed by the vehicle;

FIG. 2C illustrates the secondary device included in a wristband/watch;

FIG. 3 illustrates a method for remotely controlling functions of a vehicle according to the present teachings;

FIG. 4 illustrates an exemplary gesture made by a user moving an accelerometer according to the present teachings, the gesture representing a desired vehicle function to be carried out;

FIG. 5 illustrates another exemplary gesture according to the present teachings;

FIG. 6A illustrates an additional exemplary gesture;

FIG. 6B illustrates yet another exemplary gesture; and

FIG. 7 illustrates a further exemplary gesture.

Corresponding reference numerals indicate corresponding parts throughout the several views of the drawings.

### DETAILED DESCRIPTION

Example embodiments will now be described more fully with reference to the accompanying drawings.

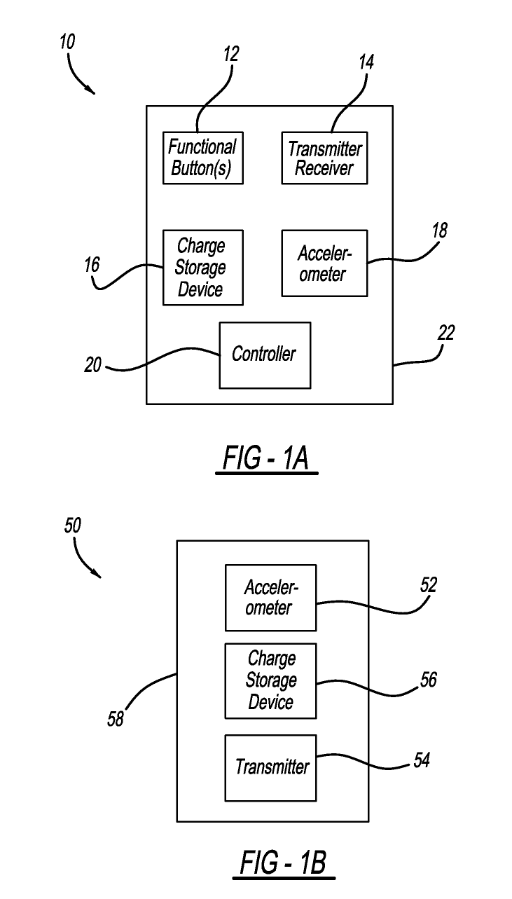

With initial reference to FIG. 1, a device according to the present teachings for remotely controlling functions of a vehicle is generally illustrated at reference numeral 10. The device 10 generally includes one or more functional buttons 12, a transmitter and optional receiver 14, a charge storage device 16, an accelerometer 18, and a controller 20, all of which may be present in a single housing 22. The accelerometer 18 and the controller 20 may be separate components, or may be integrated into a single component, such as a processor. The device 10 can be any suitable device, such as a key fob or a smart device. Exemplary smart devices include smart phones, tablet computers, personal laptop computers or any other suitable device with a controller/microprocessor, a transmitter, and optionally a receiver. The vehicle can be any suitable vehicle, such as a car, truck, utility vehicle, recreational vehicle, military vehicle, aircraft, watercraft, spacecraft, etc. The exemplary features of the device 10 will now be described.

The functional button(s) 12 can be one or more suitable buttons, which when depressed by a user cause the device 10 to transmit a signal using the transmitter 14 to instruct a vehicle to carry out a particular function designated by the functional button 12. For example, the functional button 12 may be an unlock button, which when depressed causes the device 10 to transmit an unlock signal to the vehicle. Other functions that may be associated with the functional button(s) 12 may include the following: door lock or unlock, remote start, alarm, trunk open or close, lift gate open or close, or windows open or close.

The transmitter 14 may be any suitable wireless transmitter, such as a radio transmitter or a Bluetooth transmitter. The transmitter 14 is suitable for transmitting functional commands from the device 10 to a vehicle present within a suitable range of the device 10. The device 10 may also include a receiver at 14, which may be any suitable receiver for receiving signals from a vehicle or a secondary device 50 described herein and illustrated in FIG. 1B, the secondary device 50 including an accelerometer 52. The receiver 14 can be configured to, for example, receive radio signals, Bluetooth signals, or any other suitable wireless transmission signal.

The charge storage device 16 may be any suitable device configured to store an electrical charge for powering the features of the device 10. For example, the charge storage device 16 can be any suitable battery.

The accelerometer 18 can be any suitable accelerometer for detecting and recognizing movement of the device 10. For example, the accelerometer 18 can be configured to measure proper acceleration of the device 10. The accelerometer 18 is configured to transfer measured proper acceleration readings to the controller 20.

The controller 20 may be any suitable controller, such as or including a microprocessor. The controller 20 is in receipt of proper acceleration data from the accelerometer 18, and is configured to analyze and decipher data received from the accelerometer 18. For example, the controller is configured to identify gestures, such as air gestures, made by a user moving the accelerometer 18 or the accelerometer 52 of the secondary device 50. The gestures represent functional commands to be transmitted to the vehicle using the transmitter 14. The controller 20 is configured to recognize any one of a number of predefined gestures stored therein, for example. The predefined gestures are each associated with predefined functional commands to be transmitted to the vehicle, such as the gestures described herein.

The controller 20 is also configured to be programmed by a user to recognize custom gestures provided by the user. The controller 20 is further configured to associate the customized gestures with one or more vehicle commands identified by the user. For example, the controller 20 may be programmed by a user to recognize a thumbs-up (hitchhiking gesture) with a functional command summoning the user's autonomous vehicle to pick-up the user.

With additional reference to FIG. 1B, the secondary device 50 includes, for example, the accelerometer 52, a transmitter 54, and a charge storage device 56, each of which may be present within a housing 58. The accelerometer 52 is similar to, or the same is, the accelerometer 18, and thus the description of the accelerometer 18 set forth above also applies to the accelerometer 52. The transmitter 54 is any suitable transmitter for transmitting signals to the device 10 for receipt by the receiver 14. For example, the transmitter 54 can be any suitable radio transmitter or Bluetooth transmitter. The charge storage device 56 can be similar to, or the same as, the charge storage device 16 described above, and thus the description of the charge storage device 16 set forth above also applies to the charge storage device 56. For example, the charge storage device 56 can be any suitable battery. The accelerometer 52 of the secondary device 50 generally takes the place of, or supplements, the accelerometer 18 of the device 10, which can be a primary device 10. Thus when the secondary device 50 is present and includes the accelerometer 52, the primary device 10 need not include the accelerometer 18. Further, the primary device 10 can operate independently of the secondary device 50.

The secondary device 50 provides additional functionality and additional options for placement of an accelerometer, such as the accelerometer 52. Thus the secondary device 50 can be located remote to the primary device 10, and proper acceleration readings measured by the accelerometer 52 can be transmitted by way of the transmitter 54 to the controller 20, which identifies gestures made by a user moving the accelerometer 52 and the secondary device 50, the gestures representing functional commands to be transmitted to a vehicle ultimately by the transmitter 14. The secondary device 50 is typically smaller than the primary device 10, thereby providing additional options for placement of the secondary device 50.

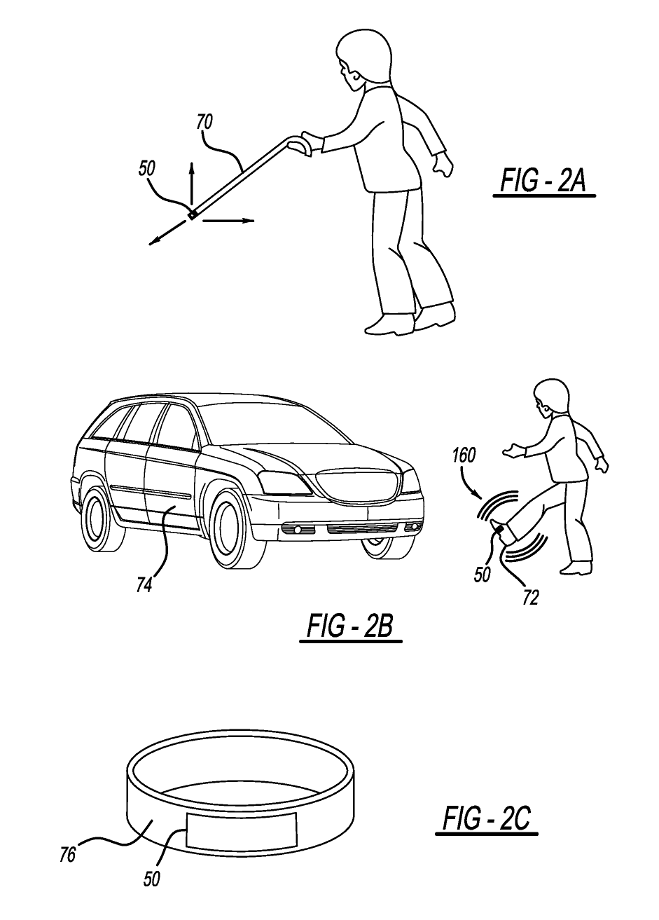

FIGS. 2A-2C illustrates exemplary options for placement of the secondary device 50. For example and with initial reference to FIG. 2A, the device 50 may be present in a cane 70. Placement of the secondary device 50 in the cane 70 provides numerous advantages. For example, if the user has the primary device 10 stored in a bag or their pocket, the secondary device 50 makes it unnecessary for the user to retrieve the primary device 10. FIG. 2B illustrates the secondary device 50 present in a user's shoe 72, and illustrates an exemplary vehicle for receipt of functional commands at reference numeral 74. FIG. 2C illustrates the secondary device 50 present in a wristband or watch 76. In place of the secondary device 50, the wristband 76 may include or be the primary device 10. For example, the housing 22 of the primary device 10 may be the wristband or watch 76.

Thus upon movement by a user of the cane 70, the shoe 72, or the wristband/watch 76 including the secondary device 50, proper acceleration data from the accelerometer 52 is transmitted by the transmitter 54 for receipt by the controller 20 by way of the receiver 14 of the primary device 10. The controller 20 then identifies any gestures made by the user representing functional commands to be transmitted to the vehicle 74, and transmits the functional commands using the transmitter 14.

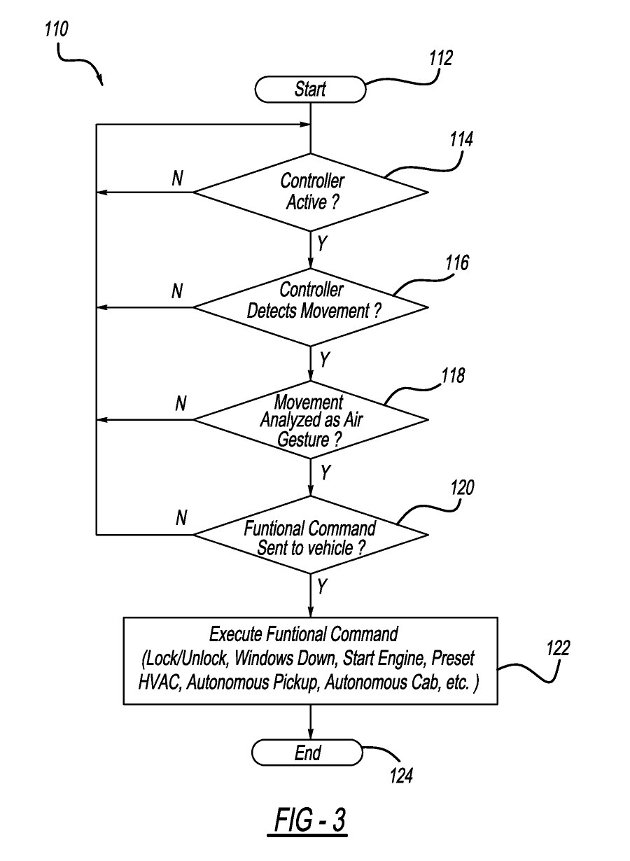

With additional reference to FIG. 3, an exemplary method according to the present teachings is illustrated at reference numeral 110. The method 110 can be performed with the primary device 10 and optionally the secondary device 50, or any other suitable device(s). The method 110 starts at block 112 where, for example, the primary and/or secondary devices 10 and 50 can be awoken or powered on by the charge storage devices 16 and 56 upon movement of the devices 10 and 50 as recognized by the accelerometers 18 and 52 respectively. From block 112, the method 110 proceeds to block 114 where the method confirms that the controller 20 is active. If the controller 20 is not active, the method 110 returns to block 14 until the controller 20 is active.

Once the controller 20 is active, the method 110 proceeds to block 116, where the controller 20 determines if movement has been detected by the accelerometer 18 and/or the accelerometer 52. If no movement has been detected, then the method 110 returns to block 114 or block 116. After movement is detected, the method 110 proceeds to block 118 where the controller 30 determines if the detected movement represents a gesture made by a user representing a functional command that the user desires to be performed by the vehicle 74. If no gesture has been detected, the method 110 returns to block 114 or block 118. Once a gesture is detected, the method 110 proceeds to block 120, where the controller 20 identifies which functional command is associated with the gesture, and transmits the functional command to the vehicle 74 using transmitter 14. If no functional command is associated with the gesture, the method 110 returns to block 114.

Upon receipt of the functional command transmitted by the transmitter 14, the vehicle 74, for example, executes the functional command, which may be a functional command customized by the user as described above, or any of the following functional commands: door lock/unlock; windows up/down; engine start; activate HVAC; autonomous vehicle pickup; summons of autonomous cab; etc. After the vehicle function has been executed, confirmation of which may be sent to the device 10, the method concludes at block 124.

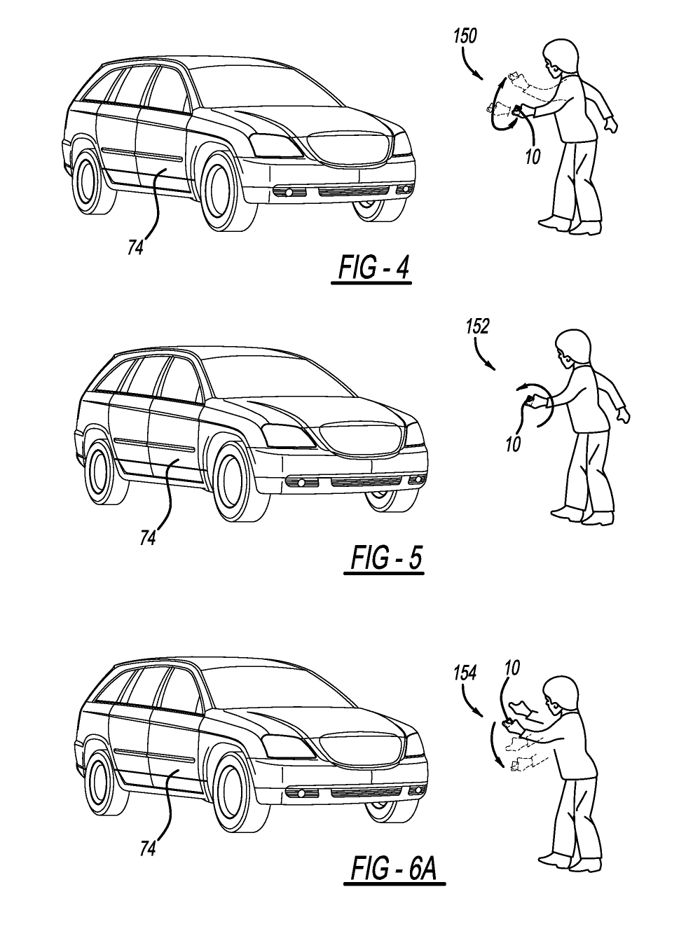

The controller 20 can be programmed to recognize any suitable gesture, and can be programmed by a manufacturer or any other suitable entity, such as a vehicle assembler, dealer, or servicer. The gestures set forth herein are merely exemplary gestures, and do not limit the number or types of gestures that can be recognized. FIGS. 4-7 illustrate exemplary gestures representing functional commands to be transmitted to the vehicle 74. For example and with reference to FIG. 4, the user may move the primary device 10 in a generally U-shaped manner or direction 150 representing a functional command to unlock the vehicle 74. Similarly, the user may move the device 10 in a generally L-shaped direction representing a functional command to lock the vehicle 74. Although the gestures 150-158 are described herein as being made while holding the primary device 10, they may also be made using the secondary device 50.

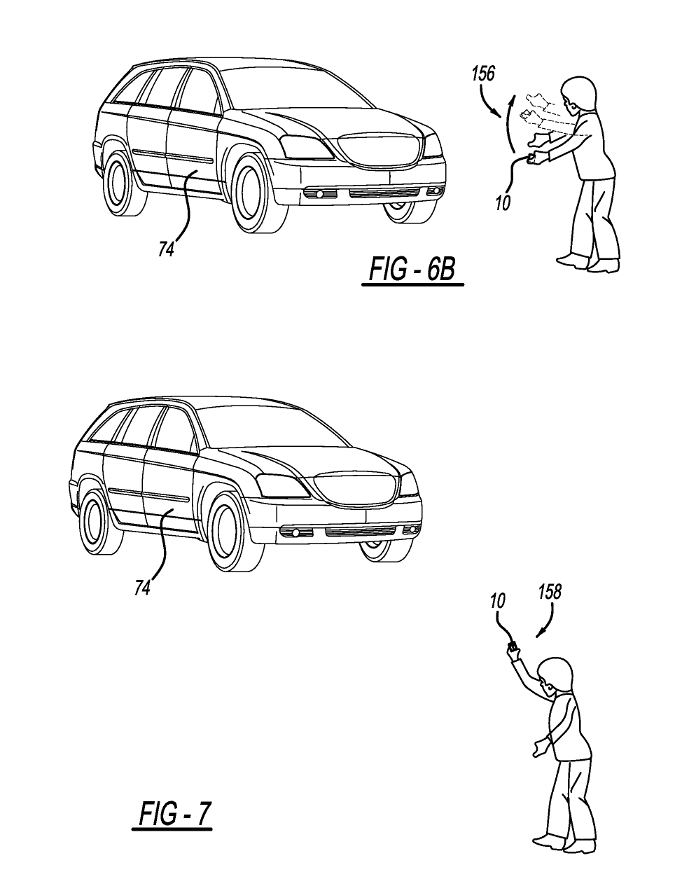

FIG. 5 illustrates another exemplary gesture at 152, which is generally a circular movement made while holding the device 10 representing a functional command to start the vehicle 74. FIG. 6A represents yet an additional exemplary gesture at 154 in which the user is generally lowering his/her hands while holding the device 10. The gesture 154 is a functional command to open the windows of the vehicle 74. FIG. 6B generally illustrates the converse of the gesture 154 at gesture 156. Gesture 156 is generally the raising of the user's hands while holding the device 10. The gesture 156 is a functional command to close the windows of the vehicle 74.

FIG. 7 illustrates an additional exemplary gesture at 158, which is generally the raising of the user's hands in a manner to denote that the user is attempting to hail or gain the attention of the vehicle 74, which can be the user's own autonomous vehicle or an autonomous taxi. For example, the gesture 158 may include raising the user's hand while holding the device 10, and holding the device 10 in a steady manner for a predetermined period of time. The gesture 158 may include holding in a depressed position one or more of the functional button(s) 12 while the user's hand is raised. The gesture 158 represents a functional command to the vehicle 74, when the vehicle 74 is an autonomous vehicle, to drive itself to the user and pick up the user. The vehicle 74 may be the user's own vehicle 74, or a for-hire vehicle, such as an autonomous taxi.

Still another gesture is illustrated in FIG. 2B at reference numeral 160. The gesture 160 is generally movement of the user's shoe 72, such as in a kicking fashion. The gesture 160 represents a functional command for the vehicle 74 to open its trunk or rear lift gate.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A system for remotely controlling functions of a vehicle, the system comprising:
a transmitter;
a charge storage device;
an accelerometer; and
a controller configured to identify gestures made by a user moving the accelerometer, the gestures representing functional commands to be transmitted to the vehicle with the transmitter.

2. The system of claim 1, further comprising a single mobile device including the transmitter, the charge storage device, the accelerometer, and the controller;
wherein the single mobile device is a key fob or a mobile smart device including a smartphone, a personal mobile tablet computer, or a laptop.

3. The system of claim 1, further comprising a primary mobile device including a receiver, the controller, and the transmitter, which is a primary transmitter; and
wherein the system further comprises a secondary mobile device including the accelerometer and a secondary transmitter configured to transmit signals identifying movement of the accelerometer to the receiver of the primary mobile device for processing by the controller.

4. The system of claim 3, wherein the primary mobile device is any one of a key fob or a mobile smart device including a smartphone, a personal mobile tablet computer, or a laptop; and
wherein the secondary mobile device is configured to be coupled with any one of the following: a cane, a wand, a shoe, a sleeve, a wrist, or a watch.

5. The system of claim 3, wherein the secondary mobile device is a wristband or a shoe insert.

6. The system of claim 1, wherein the gestures include a “U-shaped” gesture representing a door unlock command.

7. The system of claim 1, wherein the gestures include a circular gesture representing a remote vehicle start command.

8. The system of claim 1, wherein the gestures include a hand lowering movement representing an open window command, and a hand raising movement representing a window close command.

9. The system of claim 1, wherein the gestures include holding the accelerometer steady in a raised position and actuating a functional button representing a command to summon the user's autonomous vehicle or an autonomous taxi.

10. The system of claim 1, wherein the functional commands include locking doors, unlocking doors, remote vehicle start, remote vehicle shutdown, opening of trunk/lift gate, opening of windows, closing of windows, HVAC activation, alarm activation, alarm deactivation, horn activation, light flashing, multimedia on, multimedia off, or summoning autonomous vehicle.

11. The system of claim 1, wherein the controller is configured to be programmed to recognize gestures customized by the user.

12. A device for remotely controlling functions of a vehicle, the device comprising:
a transmitter;
a charge storage device;
an accelerometer;
a controller configured to identify gestures made by a user moving the accelerometer, the gestures representing functional commands to be transmitted to the vehicle with the transmitter; and
a housing including each one of the transmitter, the charge storage device, the accelerometer, and the controller.

13. The device of claim 12, wherein the device is one of a key fob or a mobile smart device including a smartphone, a personal mobile tablet computer, or a laptop.

14. The device of claim 12, wherein the functional commands include locking doors, unlocking doors, remote vehicle start, remote vehicle shutdown, opening of trunk/lift gate, opening of windows, closing of windows, HVAC activation, alarm activation, alarm deactivation, horn activation, light flashing, multimedia on, multimedia off, or summoning autonomous vehicle.

15. The device of claim 12, wherein the controller is configured to be programmed to recognize gestures customized by the user.

16. A method for remotely controlling functions of a vehicle, the method comprising:
identifying air gestures made by a user moving an accelerometer, the air gestures identified by a controller and representing functional commands for the vehicle; and
transmitting the functional commands to the vehicle.

17. The method of claim 16, further comprising wirelessly transmitting signals representing the air gestures from the accelerometer to the controller.

18. The method of claim 16, further comprising identifying air gestures for one or more of the following functional commands: locking doors, unlocking doors, remote vehicle start, remote vehicle shutdown, opening of trunk/lift gate, opening of windows, closing of windows, HVAC activation, alarm activation, alarm deactivation, horn activation, light flashing, multimedia on, multimedia off, or summoning autonomous vehicle.

19. The method of claim 16, further comprising identifying one or more of the following air gestures: a “U-shaped” gesture representing a door unlock functional command; a circular gesture representing a remote vehicle start command; a hand lowering gesture representing an open window command; a hand raising gesture representing a window close command; and holding the accelerometer steady in a raised position and actuating a functional button representing summoning of the user's autonomous vehicle or an autonomous taxi.

20. The method of claim 16, further comprising identifying air gestures customized by a user.
